(19) United States
(12) Patent Application Publication
(10) Pub. No.: US 2008/0083819 A1
(43) Pub. Date: Apr. 10, 2008

(54) Repaired pre-soldering structure of circuit board and method thereof

(76) Inventors: Shih-Ping Hsu, Hsin-chu (TW); Chao Wen Shih, Hsin-chu (TW)

Correspondence Address: Mr. Joseph A. Sawyer, Jr.;SAWYER LAW GROUP LLP, Suite 406, 2465 East Bayshore Road, Palo Alto, CA, 94303, US

(21) Appl. No.: 11/544,210

(22) Filed: Oct. 5, 2006

(51) Int. Cl. B23K 31/00

(52) U.S. Cl. 228/119

(57) ABSTRACT

A repair pre-soldering structure on a circuit board and a method thereof are proposed. A leave out on a circuit board without any pre-soldering is repaired by a micro-depositing process by applying micro droplets on the circuit board, or a short circuit formed by a pre-soldering with higher height is repaired by a micro-corrosion process. Therefore, the present invention improves fine rate of fabrication and avoids increasing fabricating time due to rework the circuit board, fabrication costs, and so on.

### FIELD OF THE INVENTION

This invention relates to a repaired pre-solder structure of a circuit board and a method thereof, and more particularly, to a method for repairing defective pre-solders formed on a circuit board by using micro-droplets.

### BACKGROUND OF THE INVENTION

With the rapid growth of portable electronic products, such as communication, network and computer products, integrated circuit package techniques follow the trend toward miniaturization and high integration. Accordingly, various integrated circuit package techniques of high integration, such as ball grid array (BGA), flip chip, chip size package (CSP) and multi chip module (MCM), are brought to the market. An integrated circuit package density is equal to a number of pins per unit area. For an integrated circuit package of high integration, shortening a layout corresponds to increasing the speed of signal transmission. Therefore, the application of conductive bumps is becoming the main stream package of high density.

The flip chip technique, for example, includes forming a plurality of electrode pads on an active surface of a semiconductor chip, and forming on a circuit board a plurality of electrical connection pads corresponding to the electrode pads. Therefore, the electrode pads are electrically connected to the electrical connection pads via pre-solders or other conductive adhesive materials formed between the semiconductor chip and the circuit board. The pre-solders, and the conductive adhesive materials as well, provide input/output and mechanical connection between the semiconductor chip and the circuit board.

However, in a pre-solder fabricating cost, some of the electrical connection pads are not covered with the pre-solders due to operating conditions, mechanical equipments or other manufacturing factors. In other words, part of the electrical connection pads formed on the circuit board are not covered with any pre-solders, thereby affecting electrical connection functionalities between the semiconductor chip and the circuit board in following package processes. As the size of components of the semiconductor chip is becoming smaller and smaller, and the circuit integration is required to be higher and higher, even such a tiny flaw will make nonrecoverable impacts on the quality of integrated circuits.

If the flaw that some of the electrical connection pads are not covered with the pre-solder is found before a reflow-soldering process is performed, the defective pre-solders can not be repaired. In result, a manufacturing yield is greatly reduced, or the whole circuit board has to be reworked to repair the defective pre-solders, and a manufacturing cycle time is increased and a fabricating cost is increased. On the other hand, if the flaw is found after the reflow-soldering process is preformed, the circuit board is useless and is discarded as junk.

Therefore, how to provide a method for repairing the electrical connection pads, to solve the drawbacks of too low the manufacturing yield and too high the fabricating cost, is becoming one of the most urgent errands in the art.

### SUMMARY OF THE INVENTION

In views of the above-mentioned problems of the prior art, it is a primary objective of the present invention to provide repaired pre-solder structure for a circuit board and a method for fabricating thereof, for increasing the manufacturing yield.

It is another objective of the present invention to provide a circuit board and a method for fabricating thereof, for overcoming the drawbacks of too long the manufacturing cycle time and too high the fabricating cost due to the reworks on the circuit board.

To achieve the above-mentioned and other objectives, a repaired pre-solder structure of a circuit board and a method thereof are provided according to the present invention. The method includes providing a circuit board comprising a plurality of electrical connection pads, an insulating protection layer being formed on the circuit board, the insulating protection layer having a plurality of opening for exposure of the electrical connection pads, forming a resist layer on the insulating protection layer, a plurality of openings being formed on the resist layer for exposure of the electrical connection pads, so as to form a plurality of pre-solders on the insulating protection layer and the electrical connection pads in the openings of the resist layer, wherein at least one of the pre-solders has a defect; and using a micro-droplet process to micro-deposit the pre-solder having the defect and the electrical connection pads, so as to repair the pre-solder on the pre-solder having the defect and the electrical connection pads.

The method further includes removing the resist layer. The pre-solder is a pre-solder tin bump. A reflow-soldering process is further performed under a temperature condition high enough to melt the pre-solder, for formation of semiconductor chips and external electronic devices.

The present invention further provides a method for repairing pre-solders of a circuit board. The method includes providing a circuit board comprising a plurality of electrical connection pads, an insulating protection layer being formed on the circuit board, the insulating protection layer having a plurality of openings for exposure of the electrical connection pads, forming a resist layer on the insulating protection layer, a plurality of openings being formed on the resist layer for exposure of the electrical connection pads, so as to form a plurality of pre-solders on the insulating protection layer and electrical connection pads in the openings of the resist layer, wherein at least one of the pre-solders has a defect; and using a micro-droplet process to micro-etch the pre-solder having the defect, so as to repair the pre-solder having the defect.

The present invention further provides a repaired pre-solder structure of a circuit board. The structure includes a circuit board comprising a plurality of electrical connection pads; an insulating protection layer formed on the circuit board; a plurality of openings formed in the insulating protection layer for exposure of the electrical connection pads; a plurality of pre-solders formed on the electrical connection pads, the pre-solders comprising at least one defective pre-solders having an insufficient height; and a repaired pre-solder deposited on a top surface of the defective pre-solder formed by a micro-droplet process.

The method for repairing pre-solders of a circuit board performs the micro deposition solder tin material on the electrical connection pads which are not covered with any pre-solders by using micro-droplets, so as to form repaired pre-solders and increase the manufacturing yield. The present invention performs a micro etching process on the pre-solders having a short circuit formed if the pre-solders are too high, to solve the drawbacks that the cost and manufacturing cycle time is increased resulting from the reworks on the circuit board.

### BRIEF DESCRIPTION OF DRAWINGS

The invention can be more fully understood by reading the following detailed description of the preferred embodiments, with reference made to the accompanying drawings, wherein:

FIGS. 1A-1C are flow schematic diagrams of repaired pre-solder structure of a circuit board and a method thereof according to the present invention; and

FIGS. 2A-2B are cross sectional views of a second embodiment of a repaired pre-solder structure of a circuit board and a method thereof according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

A repaired pre-solder structure of a circuit board and a method for fabricating the repaired pre-solder structure of the present invention are applied to a fabricating process that pre-solders are already formed. In order to simplify the drawings and specification, a circuit board having a pre-solder fabricating process finished but a resist layer is not removed yet is described as an example in the following paragraphs.

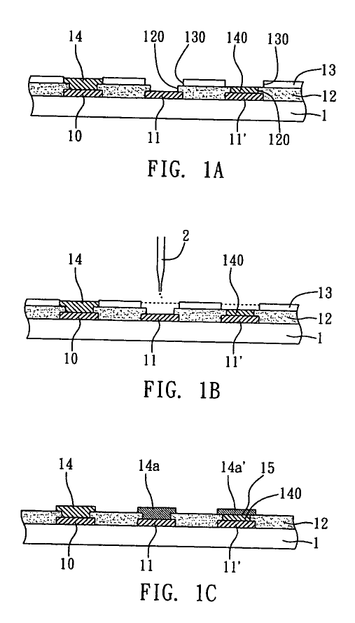

FIGS. 1A-1C are flow schematic diagrams of repaired pre-solder structure for a circuit board and a method thereof of a first embodiment according to the present invention.

As shown in FIG. 1A, a circuit board 1 having a forepart fabricating cost finished is provided. The circuit board 1 comprises a plurality of electrical connection pads (or land) 10, 11 and 11′. An insulating protection layer 12 is formed on the circuit board 1. A plurality of openings 120 are formed in the insulating protection layer 12 for exposure of the electrical connection pads 10, 11 and 11′. A resist layer 13 is formed on the insulating protection layer 12. The resist layer 13 is not a material necessary to be covered on the insulating protection layer 12. A plurality of openings 130 are formed in the resist layer 13 and corresponding in position to the electrical connection pads 10, 11 and 11′ on the circuit board 1. A plurality of pre-solders 14 are formed on the electrical connection pads 10 in the openings 130. The electrical connection pads 11 and 11′ are covered without any pre-solders and covered with a defective pre-solder 140 shorter than a normal pre-solder respectively due to fabricating factors. The pre-solders 14 and 140 are tin bumps.

As shown in FIGS. 1B and 1C, a micro-droplet 2 is used to perform a chemical reaction of micro-deposition on the electrical connection pad 11, which is not covered with any pre-solders, to form a pre-solder 14a on the electrical connection pad 11, and form on the defective pre-solder 140 a repaired pre-solder 14a′, so as to repair the pre-solders 14a and 14a′ formed on the electrical connection pads 11 and 11′. The pre-solders 14a and 14a′ are one selected from the group consisting of lead, tin, silver, copper, gold, bismuth, antimony, zinc, nickel, zirconium, magnesium, indium, tellurium and gallium.

Please refer to FIG. 1C. The resist layer 13 is removed by a chemical divesting process.

Since the pre-solders 14a and 14a′ can be tin bumps, a reflow-soldering process can be performed on the tin bumps, under a temperature condition high enough to melt the pre-solders for attaching semiconductor chips or external electronic devices.

According to the above repaired method, the present invention further provides a repaired structure, which comprises a circuit board 1 having a plurality of electrical connection pads 10, 11 and 11′. An insulating protection layer 12 is formed on the circuit board 1. A plurality of openings 120 are formed on the insulating protection layer 12 for exposure of the electrical connection pads 10, 11 and 11′. A plurality of pre-solders 14 are formed on the electrical connection pad 10. The pre-solders 14 comprise at least a defective pre-solder 140 shorter than a normal pre-solder, a repaired pre-solder 14a formed on a top surface of the defective pre-solder 140 by a micro-droplet process, and an interface 15 formed between the defective pre-solder 140 and the repaired pre-solder 14a′.

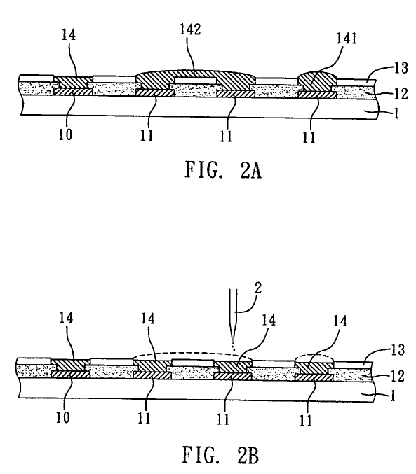

FIGS. 2A-2B are cross sectional views of a second embodiment of a repaired pre-solder structure of a circuit board and a method thereof according to the present invention. Different from the first embodiment, the second embodiment provides a circuit board having drawbacks that the pre-solders have too large the size and a short circuit exists among the pre-solders.

As shown in FIG. 2A, a circuit board 1 as shown in FIG, 1A is provided. The electrical connection pads 10 and 11 are covered with a normal pre-solder 14 and at least too high a defective pre-solder 141 respectively, or a drawback of a bridge portion 142 is formed between two pre-solders 14. In other words, the two pre-solders are shorted.

Please refer to FIG. 2B. A chemical reaction of micro-droplet 2 is applied to the pre-solder 141 formed on the circuit board 1 to perform a micro etching process and remove the pre-solder 141. Therefore, a top portion of too high the detective pre-solder 141 is removed and the pre-solder 141 becomes normal. Further, the bridge portion 141 is removed. In result, two originally connected pre-solders 14 are separated and independent. Therefore, the pre-solder 141 is repaired to have a normal size and be the normal pre-solder 14. The resist layer 13 can then be further removed (not shown).

Compared with the prior art, the repaired pre-solder structure and a method thereof perform the micro deposition solder tin material on the electrical connection pads which are not covered with any pre-solders by using micro-droplets, so as to form repaired pre-solders and increase the manufacturing yield. The present invention performs a micro etching process on the pre-solders having a short circuit formed if the pre-solders are too high, to solve the drawbacks that the cost and manufacturing cycle time is increased resulting from the reworks on the circuit board.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A method for repairing pre-solders of a circuit board, the method comprising:
providing a circuit board comprising a plurality of electrical connection pads, an insulating protection layer being formed on the circuit board, the insulating protection layer having a plurality of opening for exposure of the electrical connection pads, forming a resist layer on the insulating protection layer, a plurality of openings being formed on the resist layer for exposure of the electrical connection pads, so as to form a plurality of pre-solders on the insulating protection layer and the electrical connection pads in the openings of the resist layer, wherein at least one of the pre-solders has a defect; and
using a micro-droplet process to micro-deposit the pre-solder having the defect and the electrical connection pads, so as to repair the pre-solder on the pre-solder having the defect and the electrical connection pads.

2. The method of claim 1, wherein the defect of the pre-solder is one selected from the group consisting of an insufficient height and without formation.

3. The method of claim 1, wherein the pre-solder is a tin bump.

4. The method of claim 1, wherein the pre-solder is one selected from the group consisting of lead, tin, silver, copper, gold, bismuth, antimony, zinc, nickel, zirconium, magnesium, indium, tellurium and Gallium.

5. The method of clam 1 further comprising removing the resist layer.

6. A method for repairing pre-solders of a circuit board, the method comprising:
providing a circuit board comprising a plurality of electrical connection pads, an insulating protection layer being formed on the circuit board, the insulating protection layer having a plurality of openings for exposure of the electrical connection pads, forming a resist layer on the insulating protection layer, a plurality of openings being formed on the resist layer for exposure of the electrical connection pads, so as to form a plurality of pre-solders on the insulating protection layer and electrical connection pads in the openings of the resist layer, wherein at least one of the pre-solders has a defect; and
using a micro-droplet process to micro-etch the pre-solder having the defect, so as to repair the pre-solder having the defect.

7. The method of claim 6, wherein the defect of the pre-solder is one selected from the group consisting of too large the size and a short circuit existing between the pre-solders.

8. The method of claim 6, wherein the pre-solder is a tin bumps.

9. The method of claim 6, wherein the pre-solder is one selected from the group consisting of lead, tin, silver, copper, gold, bismuth, antimony, zinc, nickel, zirconium, magnesium, indium, tellurium and Gallium.

10. The method of clam 6 further comprising removing the resist layer.

11. A repaired pre-solder structure of a circuit board, the structure comprising:
a circuit board comprising a plurality of electrical connection pads;
an insulating protection layer formed on the circuit board;
a plurality of openings formed in the insulating protection layer for exposure of the electrical connection pads;
a plurality of pre-solders formed on the electrical connection pads, the pre-solders comprising at least one defective pre-solders having an insufficient height; and
a repaired pre-solder deposited on a top surface of the defective pre-solder formed by a micro-droplet process.

12. The structure of claim 11, wherein the pre-solder is a tin bump.

13. The structure of claim 11, wherein the pre-solder is one selected from the group consisting of lead, tin, silver, copper, gold, bismuth, antimony, zinc, nickel, zirconium, magnesium, indium, tellurium and gallium.
